(19) United States
(12) Patent Application Publication
(10) Pub. No.: US 2022/0097722 A1
(43) Pub. Date: Mar. 31, 2022

(54) VEHICLE CONTROL APPARATUS

(71) Applicant: TOYOTA JIDOSHA KABUSHIKI KAISHA, Toyota-shi (JP)

(72) Inventors: Takaya YAMASHITA, Nisshin-shi (JP); Masaho Ishida, Toyota-shi (JP); Koji Takeuchi, Toyota-shi (JP)

(73) Assignee: TOYOTA JIDOSHA KABUSHIKI KAISHA, Toyota-shi (JP)

(21) Appl. No.: 17/468,112

(22) Filed: Sep. 7, 2021

(30) Foreign Application Priority Data
Sep. 29, 2020 (JP) 2020-163225

(51) Int. Cl. B60W 50/12; B60W 50/14

(52) U.S. Cl. CPC B60W 50/12; B60W 50/14; B60W 2554/4049; B60W 2540/01; B60W 2050/143

(57) ABSTRACT

A vehicle control apparatus has doors provided on a vehicle, including at least one first door which has a first maximum opening amount and at least one second door which has a second maximum opening amount smaller than the first maximum opening amount. The vehicle control apparatus sets a distance threshold to a first value when an opening operation is carried out or is about to be carried out to at least one first door, and sets the distance threshold to a second value smaller than the first value when the opening operation is carried out or is about to be carried out to the at least one second door.

### BACKGROUND

### Field

The invention relates to a vehicle control apparatus.

### Description of the Related Art

There is known a vehicle control apparatus which is configured to execute various controls when there is a moving object behind a vehicle, and an occupant in the vehicle carries out an opening operation of opening a door of the vehicle to get out of the vehicle (for example, see JP 2005-247067 A). The aforementioned controls are, for example, an alerting control of alerting occupants in the vehicle to the moving object and a door locking control of locking the door to which the opening operation is carried out.

Some vehicles have different types of doors such as swing doors and slide doors which have different maximum opening amounts in a width direction of the vehicle. The swing door is a door which is secured to a vehicle body of the vehicle via a hinge mechanism so as to swing outward from the vehicle body. Thus, the swing door has the relatively great maximum opening amount. The slide door is a door which is secured to the vehicle body via a slide mechanism so as to slide in a longitudinal direction of the vehicle body. Thus, the slide door has the maximum opening amount smaller than the maximum opening amount of the swing door.

For example, an apparatus described in JP 2005-247067 A (hereinafter, this apparatus will be referred to as “conventional apparatus”) is configured to execute the alerting control, independently of the type of the door to which the opening operation is carried out. In particular, the conventional apparatus is configured to execute the alerting control, independently of the type of the door when there is a moving object behind the vehicle, and the opening operation is carried out. In this connection, when the vehicle has different types of the doors, problems may arise. For example, when (i) there is a moving object behind the vehicle, (ii) the moving object is likely to pass the vehicle, keeping away from the vehicle in the width direction of the vehicle, and (iii) the opening operation is carried out to the slide door, the moving object is unlikely to come close to the slide door since the maximum opening amount of the slide door is small. The conventional apparatus executes the alerting control when the moving object is unlikely to come close to the slide door. With this, the occupants of the vehicle may feel bothersome.

### SUMMARY

An object of the invention is to provide a vehicle control apparatus which is configured to change execution conditions for the aforementioned various controls such as the alerting control and/or the door locking control, depending on the types of the doors of the vehicle which have the different maximum opening amounts.

A vehicle control apparatus according to the invention comprises doors, at least one sensor, and a control unit. The doors are provided on a vehicle. The doors includes at least one first door and at least one second door. The at least one first door has a first maximum opening amount. The at least one second door has a second maximum opening amount smaller than the first maximum opening amount. The at least one sensor acquires object information on objects in a rear area behind the vehicle. The control unit is configured to execute one or both of a first control and a second control when the control unit determines that (i) an opening operation of opening the door is carried out or is about to be carried out, and (ii) a first condition and a second condition are satisfied, based on the object information.

The first control is a control of alerting occupants of the vehicle. The second control is a control of preventing the door to which the opening operation is carried out or is about to be carried out from opening. The first condition is a condition that a moving object approaches the vehicle from behind the vehicle. The second condition is a condition that a moving object distance between a position of the vehicle and a predicted position of the moving object coming near the vehicle, is shorter than or equal to a distance threshold.

The control unit is configured to set the distance threshold to a first value when the opening operation is carried out or is about to be carried out to at least one first door, and set the distance threshold to a second value smaller than the first value when the opening operation is carried out or is about to be carried out to the at least one second door.

The vehicle control apparatus according to the invention is configured to change the distance threshold of the second condition, depending on which of the at least one first door and the at least one second door having the different maximum opening amounts, the opening operation is carried out or is about to be opened. When the opening operation is carried out or is about to be carried out to the at least one second door having the smaller maximum opening amount, the vehicle control apparatus according to the invention sets the distance threshold to the second value smaller than the first value which is set as the distance threshold when the opening operation is carried out or is about to be carried out to the at least one first door.

For example, when (i) the at least one first door is a swing door, and the at least one second door is a slide door, (ii) there is a moving object behind the vehicle, and (iii) the moving object is likely to pass the vehicle at the side thereof, keeping away from the vehicle in the width direction of the vehicle, the second condition is not satisfied if the opening operation is carried out or is about to be carried out to the slide door (i.e., the at least one second door). Thus, the vehicle control apparatus according to the invention does not execute the first control and/or the second control. Thus, the vehicle control apparatus according to the invention can execute the first control and/or the second control in consideration of the maximum opening amount of the door to which the opening operation is carried out or is about to be carried out.

According to an aspect of the invention, the control unit may be configured to calculate, as the moving object distance, a distance between a position of the vehicle and a predicted position of the moving object coming at the side of the door to which the opening operation is carried out or is about to be carried out.

The vehicle control apparatus according to this aspect of the invention executes the first control and/or the second control under an appropriate situation that the moving object is likely to come close to the door to which the opening operation is carried out or is about to be carried out.

In one or more embodiments of the invention, the control unit may be realized by a micro-processor programmed to execute one or more functions described in the description. In one or more embodiments of the invention, the control unit may be entirely or partially realized by hardware configured by ASIC, i.e., integrated circuits dedicated to one or more applications.

Elements of the invention are not limited to elements of embodiments and modified examples of the invention described along with the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle to which a vehicle control apparatus according to an embodiment of the invention is applied.

FIG. 2 is a view which shows a configuration of the vehicle control apparatus according to the embodiment.

FIG. 3 is a view which shows a situation that a moving object is approaching the vehicle from behind the vehicle.

FIG. 4 is a view describing a relationship between maximum opening amounts of doors (a front door and a rear door) of the vehicle and a position of the moving object.

FIG. 5 is a view which shows a situation that the moving object passes the vehicle at the side thereof and moves ahead of the vehicle.

FIG. 6 is a view which shows a control routine executed by a CPU of a vehicle control ECU according to the embodiment.

FIG. 7 is a view which shows a distance between a position of the vehicle and a predicted position of the moving object coming near the vehicle according to a modified example.

### DESCRIPTION OF THE EMBODIMENTS

<Configuration>

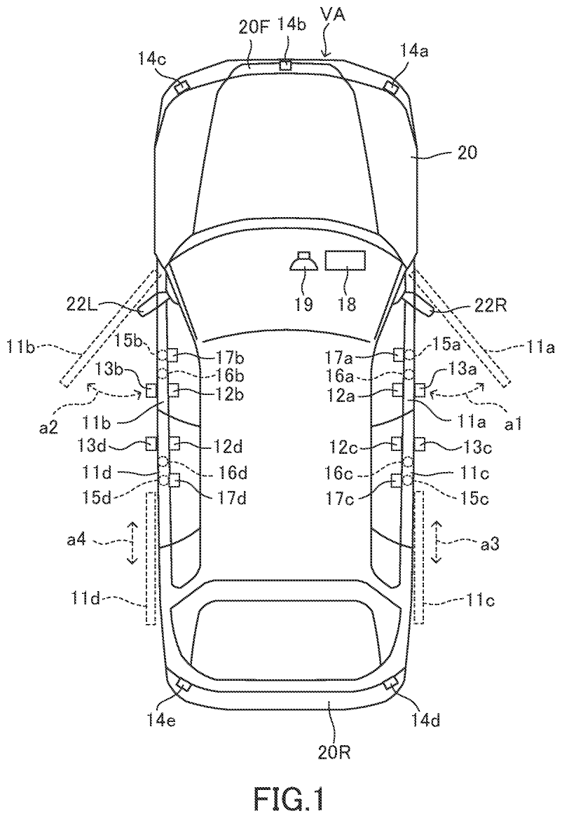

A vehicle control apparatus according to an embodiment of the invention is applied to a vehicle VA shown in FIG. 1. The vehicle VA has front doors 11a and 11b, and rear doors 11c and 11d. Hereinafter, the vehicle control apparatus according to the embodiment will be referred to as “embodiment apparatus”.

The front doors 11a and 11b are secured to a vehicle body 20 of the vehicle VA via hinge mechanisms (not shown), respectively. As shown by arrows a1 and a2, the front doors 11a and 11b can swing about vertical axes with respect to the vehicle body 20, respectively. Doors such as the front doors 11a and 11b are called as swing doors.

The front door 11a has an inside lever 12a and an outside lever 13a. The inside lever 12a is provided on an inside portion of the front door 11a. The outside lever 13a is provided on an outside portion of the front door 11a. The inside lever 12a and the outside lever 13a are levers used to open the front door 11a. Similarly, the front door 11b has an inside lever 12b and an outside lever 13b.

The rear doors 11c and 11d are secured to the vehicle body 20 via slide mechanisms (not shown), respectively. As shown by arrows a3 and a4, the rear doors 11c and 11d can slide in a longitudinal direction of the vehicle VA with respect to the vehicle body 20, respectively. Doors such as the rear doors 11c and 11d are called as slide doors.

The rear door 11c has an inside lever 12c and an outside lever 13c. The inside lever 12c is provided on an inside portion of the rear door 11c. The outside lever 13c is provided on an outside portion of the rear door 11c. The inside lever 12c and the outside lever 13c are levers used to open the rear door 11c. Similarly, the rear door lid has an inside lever 12d and an outside lever 13d.

The front doors 11a and 11b, and the rear doors 11c and 11d are also referred as “door 11”, respectively. Similarly, the inside levers 12a to 12d are also referred to as “inside lever 12”, respectively, and the outside levers 13a to 13d are also referred to as “outside lever 13”, respectively.

Further, the vehicle VA has radar sensors 14a to 14e, door switches 15a to 15d, door locking devices 16a to 16d, lamps 17a to 17d, a displaying device 18, and a buzzer (an alerting sound generating device) 19.

The radar sensors 14a to 14e are also referred to as “radar sensor 14”, respectively. Similarly, the door switches 15a to 15d are also referred to as “door switch 15”, respectively, the door locking devices 16a to 16d are also referred to as “door locking device 16”, respectively, and the lamps 17a to 17d are also referred to as “lamp 17”, respectively.

Each radar sensor 14 has a radar transmitting/receiving section (not shown) and a signal processing section (not shown). The radar transmitting/receiving section transmits radio waves having a millimeter wave band (hereinafter, the radio wave will be referred to as “millimeter wave”) and receives the millimeter waves (i.e., the reflected waves) reflected on objects within a radiation area. The signal processing section acquires object information on the objects around the vehicle VA, based on a phase difference between the transmitted millimeter wave and the received reflected wave, an attenuation level of the reflected wave, and a time taken to receive the reflected wave from transmitting the millimeter wave. It should be noted that the objects in this description include moving objects such as walking persons, bicycles, and vehicles, and non-moving objects such as guard rails and fences. The object information includes a distance between the vehicle VA and the object, and a relative position (including an orientation) of the object with respect to the vehicle VA.

The radar sensor 14a is provided on a right conner portion of a front portion 20F of the vehicle body 20. The radar sensor 14a mainly acquires the object information on the objects in a right front area with respect to the vehicle VA. The radar sensor 14b is provided on a center portion of the front portion 20F of the vehicle body 20. The radar sensor 14b acquires the object information on the objects in a front area with respect to the vehicle VA. The radar sensor 14c is provided on a left corner portion of the front portion 20F of the vehicle body 20. The radar sensor 14c mainly acquires the object information on the objects in a left front area with respect to the vehicle VA. The radar sensor 14d is provided on a right conner portion of a rear portion 20R of the vehicle body 20. The radar sensor 14d mainly acquires the object information on the objects in a right rear area with respect to the vehicle VA. The radar sensor 14e is provided on a left corner portion of the rear portion 20R of the vehicle body 20. The radar sensor 14e mainly acquires the object information on the objects in a left rear area with respect to the vehicle VA. It should be noted that additional sensors may be provided on side mirrors 22R and 22L, respectively.

The door switches 15a to 15d are provided on the doors 11a to 11d, respectively. The door switch 15 outputs an ON signal (i.e., a high level signal) when the corresponding door is opened. It should be noted that the door switch 15 continues to output the ON signals until the corresponding door is closed since the corresponding inside lever 12 or the corresponding outside lever 13 is operated. The door switch 15 outputs an OFF signal (i.e., a low level signal) when the corresponding door is closed.

The door locking devices 16a to 16d are provided on the doors 11a to 11d, respectively. The door locking devices 16 are configured to lock the corresponding doors, respectively.

The lamps 17a to 17d are provided on the inside portions of the doors 11a to 11d, respectively. Thus, the occupants of the vehicle VA can see the lamps 17a to 17d when they get out of the vehicle VA.

The displaying device 18 is a multi-information display provided in front of a driver's seat. The displaying device 18 displays measured values of a vehicle moving speed and an engine rotation speed, and various information such as alerting signs and alerting messages as described later. It should be noted that the displaying device 18 may be a head-up display.

The buzzer 19 is provided at a position near the driver's seat. The buzzer 19 is configured to output alerting sounds.

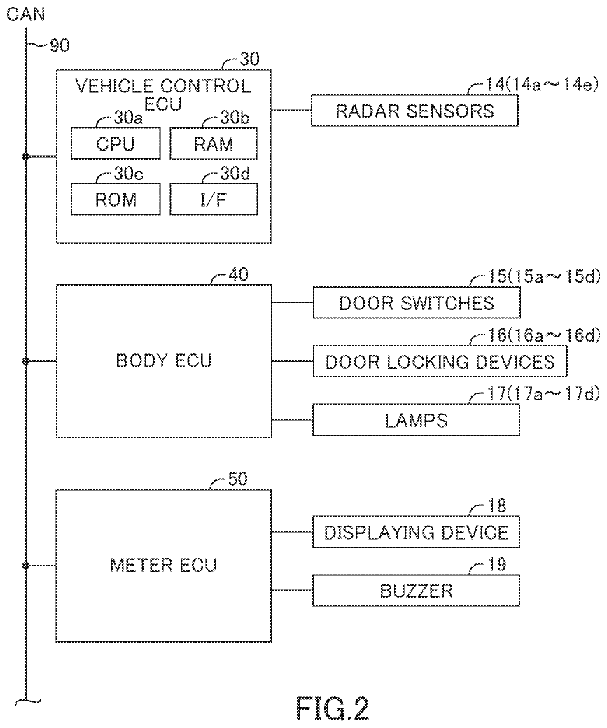

As shown in FIG. 2, the vehicle VA has a vehicle control ECU 30, a body ECU 40, and a meter ECU 50.

Each of these ECUs 30, 40, and 50 is an electronic control unit having a micro-computer as a main component. The ECUs 30, 40, and 50 are electrically connected to each other via CAN (Controller Area Network) 90. The ECUs 30, 40, and 50 can send information to and receive information from each other via the CAN 90. In this description, the micro-computer includes a CPU, a RAM, a ROM, and an interface (I/F). For example, the vehicle control ECU 30 has a micro-computer including a CPU 30a, a RAM 30b, a ROM 30c, and an interface (I/F) 30d. The CPU 30a realizes various functions described later by executing instructions, programs, and routines stored in the ROM 30c.

The vehicle control ECU 30 is electrically connected to the radar sensors 14. The vehicle control ECU 30 acquires the object information acquired by the radar sensors 14 each time a predetermined time (hereinafter, this predetermined time will be referred to as “first time dT”) elapses. The vehicle control ECU 30 memorizes the acquired object information in the RAM 30b. It should be noted that the vehicle control ECU 30 memorizes data sets of the object information acquired during a period having a time length of at least several times of the first time dT in order to determine whether the detected object is a moving object to pay attention. The vehicle control ECU 30 calculates parameters representing a relationship between the vehicle VA and the object, based on the object information. The parameters representing the relationship between the vehicle VA and the object include a distance between the vehicle VA and the object, a moving direction of the object with respect to the vehicle VA, and a relative speed of the object with respect to the vehicle VA.

It should be noted that the vehicle control ECU 30 is also electrically connected to sensors (not shown) for detecting operation states of the vehicle VA such as a vehicle moving speed sensor, a steering angle sensor, an acceleration pedal operation amount sensor, and a brake pedal operation amount sensor. The vehicle control ECU 30 acquires information on the operation states of the vehicle VA from the sensors.

The body ECU 40 is electrically connected to the door switches 15, the door locking devices 16, and the lamps 17. The body ECU 40 receives signals from the door switches 15 and outputs these received signals to the vehicle control ECU 30.

Further, the body ECU 40 controls the door locking devices 16 in response to commands from the vehicle control ECU 30. The body ECU 40 lights the lamps 17 in response to commands from the vehicle control ECU 30.

The meter ECU 50 is electrically connected to the displaying device 18 and the buzzer 19. The meter ECU 50 causes the buzzer 19 to output the alerting sounds in response to commands from the vehicle control ECU 30. Further, the meter ECU 50 displays the alerting signs and the alerting messages on the displaying device 18 in response to commands from the vehicle control ECU 30.

<Summary of Controls>

Next, controls executed when an opening operation of opening the door 11 is carried out with a moving object approaching the vehicle VA from behind the vehicle VA. In this embodiment, the opening operation is an operation applied to the inside lever 12. The vehicle control ECU 30 receives the signals from the door switches 15 via the body ECU 40. The vehicle control ECU 30 determines whether the opening operation is carried out to at least one door 11 with the vehicle VA stopped.

When the vehicle control ECU 30 determines that the opening operation is carried out to the at least one door 11, the vehicle control ECU 30 determines whether a first condition is satisfied, based on the parameters representing the relationship between the vehicle VA and the object. The first condition is a condition for determining whether there is a moving object approaching the vehicle VA from behind the vehicle VA.

The first condition is satisfied when conditions A1 to A3 described below are all satisfied.

The condition A1 is a condition that a moving speed Vs of the object (i.e., the relative speed of the moving object with respect to the vehicle VA) is greater than a predetermined first speed threshold Vth1 which is substantially near zero.

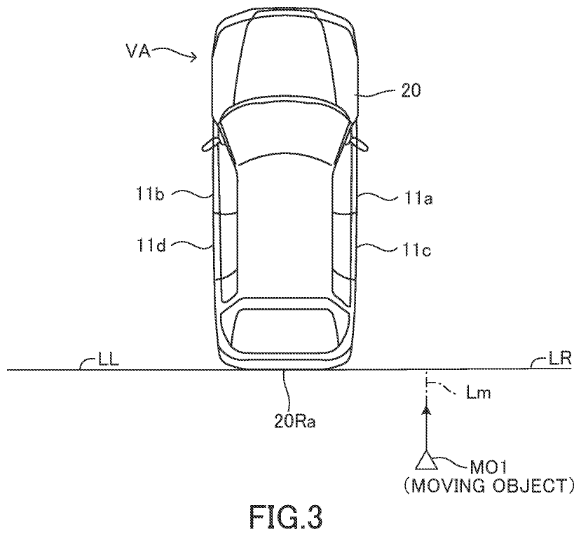

The second condition A2 is a condition that an extension line Lm of a moving direction of the object intersects a line La which extends in a width direction of the vehicle VA from a rear end portion 20Ra of the vehicle body 20. It should be noted that the vehicle control ECU 30 sets the line La, depending on which of the doors 11 the opening operation is carried out to. When the opening operation is carried out to the right door 11a or 11c, the vehicle control ECU 30 sets the line La to a first line LR which extends in a rightward direction from the rear end portion 20Ra of the vehicle body 20 as shown in FIG. 3 (La←LR). When the opening operation is carried out to the left door 11b or 11d, the vehicle control ECU 30 sets the line La to a second line LL which extends in a leftward direction from the rear end portion 20Ra of the vehicle body 20 as shown in FIG. 3 (La←LL).

The condition A3 is a condition that a predicted time Tk is equal to or shorter than a predetermined time threshold Tth. The predicted time Tk is a time which the object predictively takes to reach the line La. The predicted time Tk is calculated by dividing the distance between the object and the line La by the moving speed Vs of the object.

When (i) there is a moving object MO1 such as a walking person behind the vehicle VA as shown in FIG. 3, and (ii) the occupant operates the inside lever 12a or 12c to get out of the vehicle VA, the vehicle control ECU 30 determines that the opening operation is carried out, and sets the first line LR as the line La. In an example shown in FIG. 3, the moving speed Vs of the moving object MO1 is greater than a speed threshold Vth. In addition, the extension line Lm of the moving direction of the moving object MO1 shown by a dashed-dotted line intersects the line La. In addition, the predicted time Tk which the moving object MO1 predictively takes to reach the line La, is equal to or shorter than the predetermined time threshold Tth. Thus, the first condition is satisfied.

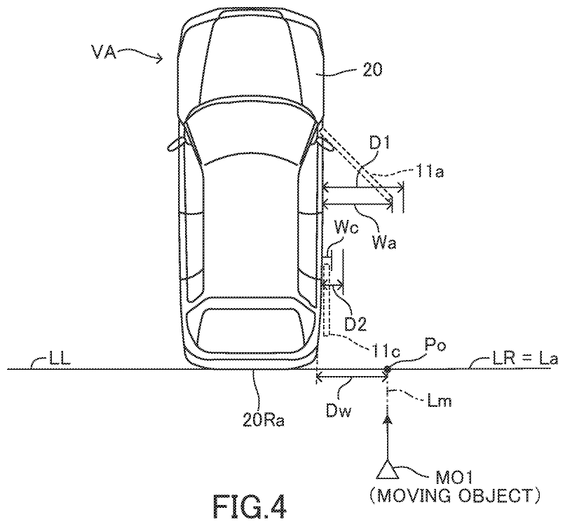

As shown in FIG. 4, a maximum opening amount of the front door 11a and a maximum opening amount of the rear door 11c are different from each other. The front door 11a, i.e., the swing door has a first maximum opening amount Wa, and the rear door 11c, i.e., the slide door has a second maximum opening amount Wc. The second maximum opening amount Wc is smaller than the first maximum opening amount Wa. For example, when the opening operation is carried out to the rear door 11c, the moving object MO1 is unlikely to come close to the rear door 11c. When the moving object MO1 is unlikely to come dose to the rear door 11c, and the occupants of the vehicle VA are alerted, the occupants may feel bothersome.

Accordingly, the vehicle control ECU 30 determines whether a second condition described below is satisfied in addition to determining whether the first condition is satisfied. The second condition is a condition for determining whether the object (the moving object) comes close to the door to which the opening operation is carried out. Hereinafter, the door to which the opening operation is carried out, will be referred to as “door DR_op”.

In particular, the second condition is satisfied when a distance Dw is equal to or shorter than a first distance threshold Dth1. The distance Dw is a distance between (i) a position of the vehicle VA and (ii) a predicted position of the moving object MO1 coming near the vehicle VA. In this embodiment, the distance Dw is a distance in the width direction of the vehicle VA between (i) the position of the vehicle VA and (ii) the predicted position Po of the moving object MO1 assumptively reaching the line La. It should be noted that the predicted position Po is an intersecting position of the extension line Lm of the moving direction of the moving object MO1 and the line La.

The vehicle control ECU 30 changes the first threshold distance Dth1, depending on a type of the door DR_op. In particular, when the door DR_op is the front door, i.e., the swing door, the vehicle control ECU 30 sets the first threshold distance Dth1 to a first distance D1 (Dth1←D1). The first distance D1 is for the swing door. In particular, the first distance D1 is a value acquired by adding a predetermined first margin to the first maximum opening amount Wa. When the door DR_op is the rear door, i.e., the slide door, the vehicle control ECU 30 sets a second distance D2 to the first threshold distance Dth1 (Dth1←D2). The second distance D2 is for the slide door. In particular, the second distance D2 is a value acquired by adding a predetermined second margin to the second maximum opening amount Wc, The second distance D2 is shorter than the first distance D1 (D2<D1). The vehicle control ECU 30 can determine whether the moving object MO1 comes close to the door DR_op with setting the first threshold distance Dth1 of the second condition, depending on a type of the door DR_op to which the opening operation is carried out, i.e., depending on which of the swing door and the slide door the opening operation is carried out to.

When the first and second conditions are both satisfied, the vehicle control ECU 30 executes a first control and a second control. The first control is a control of alerting the occupants that there is the moving object. The second control is a control of preventing the door DR_op from being opened.

<First Control>

The vehicle control ECU 30 executes the first control as follows. The vehicle control ECU 30 sends a displaying control command and a buzzer control command to the meter ECU 50. The displaying control command is a command of controlling the displaying device 18. The buzzer control command is a command of controlling the buzzer 19. The meter ECU 50 executes an alerting displaying control in response to the displaying control command. The alerting displaying control is a control of displaying alerting signs and alerting messages on the displaying device 18. The meter ECU 50 executes a sound generating control in response to the buzzer control command. The sound generating control is a control of causing the buzzer 19 to generate alerting sounds. In addition, the vehicle control ECU 30 sends a lighting control command to the body ECU 40. The lighting control command is a command of controlling the lamps 17. The body ECU 40 executes a lighting control in response to the lighting control command. The lighting control is a control of lighting the lamp 17 of the door DR_op.

<Second Control>

The vehicle control ECU 30 executes the second control as follows. The vehicle control ECU 30 sends a door locking control command to the body ECU 40. The door locking control command is a command of controlling the door lock device 16 of the door DR_op. The body ECU 40 executes a door locking control in response to the door locking control command. The door locking control is a control of locking the door DR_op.

It should be noted that when the door DR_op is the slide door 11c or 11d, the body ECU 40 may execute a door stopping control in place of the door locking control. The door stopping control is a control of stopping a displacement of the slide door in the longitudinal direction of the vehicle VA before the slide door reaches its maximally-opened position.

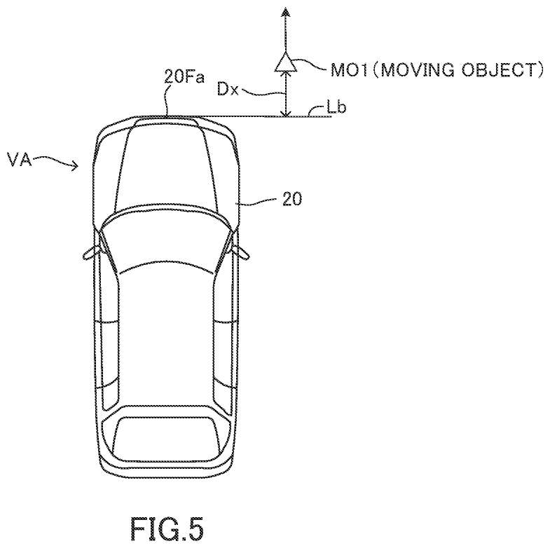

After the vehicle control ECU 30 starts to execute the first and second controls, the vehicle control ECU 30 determines whether a predetermined terminating condition is satisfied. As shown in FIG. 5, the predetermined terminating condition is satisfied when (i) the moving object MO1 moves away from the vehicle VA, and (ii) a distance Dx becomes equal to or longer than a second distance threshold Dth2. The distance Dx is a distance between the moving object MO1 and a line Lb which extends in the width direction of the vehicle VA from a front end portion 20Fa of the vehicle body 20. When the predetermined terminating condition is satisfied, the vehicle control ECU 30 terminates executing the first and second controls.

As described above, the vehicle control ECU 30 changes the first threshold distance Dth1 of the second condition, depending on the type of the door DR_op to which the opening operation is carried out, i.e., depending on which of the sling door and the slide door the opening operation is carried out to. For example, when the opening operation is carried out to the rear door 11c, i.e., the slide door in an example shown in FIG. 4, the first threshold distance Dth1 is set to the second distance D2. The moving object MO1 passes the vehicle, keeping away from the rear door 11c. Thus, the second condition is not satisfied. Thus, the vehicle control ECU 30 does not execute the first and second controls. Thus, the occupants of the vehicle do not feel bothersome.

<Operations>

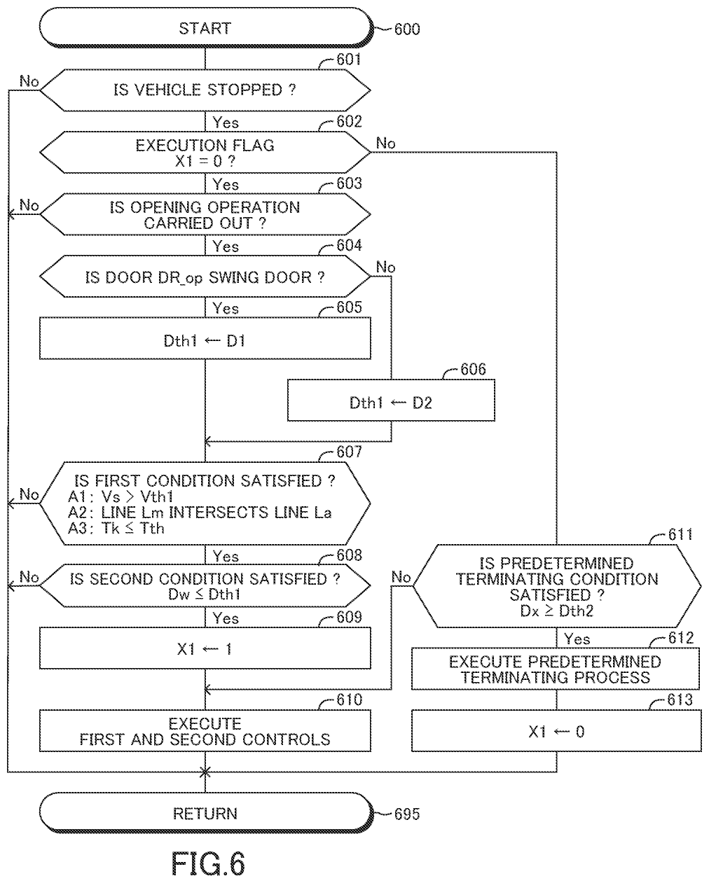

Next, operations of the CPU 30a of the vehicle control ECU 30 will be described. Hereinafter, the CPU 30a will be simply referred to as “CPU”. The CPU is configured or programmed to execute a control routine shown by a flowchart in FIG. 6 each time a predetermined time equal to or longer than the first time dT elapses.

It should be noted that the CPU acquires the object information from the radar sensors 14 and calculates the parameters representing the relationship between the vehicle VA and the object. In addition, the CPU acquires the signals of the door switches 15 from the body ECU 40 each time the first time dT elapses.

At a predetermined timing, the CPU starts to execute a process of the routine shown in FIG. 6 and proceeds with the process to a step 601 to determine whether the vehicle VA is stopped, i.e., the vehicle moving speed detected by the vehicle moving speed sensor is zero.

When the vehicle VA is not stopped, the CPU determines “No” at the step 601 and proceeds with the process directly to a step 695 to terminate executing this routine once.

On the other hand, when the vehicle VA is stopped, the CPU determines “Yes” at the step 601 and proceeds with the process to a step 602 to determine whether a value of an execution flag X1 is “0”. When the value of the execution flag X1 is “0”, the execution flag X1 represents that the first and second controls are not executed. When the value of the execution flag X1 is “1”, the execution flag X1 represents that the first and second controls are being executed.

When the value of the execution flag X1 is “0”, the CPU determines “Yes” at the step 602 and proceeds with the process to a step 603 to determine whether the opening operation is carried out to at least one of the doors 11. When the opening operation is not carried out, the CPU determines “No” at the step 603 and proceeds with the process directly to the step 695 to terminate executing this routine once.

On the other hand, when the opening operation is carried out to at least one of the doors 11, the CPU determines “Yes” at the step 603 and proceeds with the process to a step 604 to determine whether the door DR_op to which the opening operation is carried out to, is the swing door, i.e. the front door 11a or 11b. When the door DR_op is the swing door, the CPU determines “Yes” at the step 604 and proceeds with the process to a step 605 to set the first distance D1 as the first threshold distance Dth1. Then, the CPU proceeds with the process to a step 607.

On the other hand, when the door DR_op is the slide door, i.e., the rear door 11c or 11d, the CPU determines “No” at the step 604 and proceeds with the process to a step 606 to set the second distance D2 as the first threshold distance Dth1. Then, the CPU proceeds with the process to the step 607.

It should be noted that when the opening operations are simultaneously carried out to the swing door and the slide door of the same side (i.e., the right side or the left side) of the vehicle body 20, the CPU proceeds with the process to the step 605 to set the first distance D1 as the first threshold distance Dth1.

When the CPU proceeds with the process to the step 607, the CPU determines whether the first condition described above is satisfied. In particular, the CPU determines whether the conditions A1 to A3 described above are all satisfied. When the first condition is not satisfied, the CPU determines “No” at the step 607 and proceeds with the process directly to the step 695 to terminate executing this routine once.

On the other hand, when the first condition is satisfied, the CPU determines “Yes’ at the step 607 and proceeds with the process to a step 608 to determine whether the second condition described above is satisfied. In particular, the CPU determines whether the distance Dw is equal to or shorter than the first threshold distance Dth1. When the second condition is not satisfied, the CPU determines “No” at the step 608 and proceeds with the process directly to the step 695 to terminate executing this routine once.

When the second condition is satisfied, the CPU determines “Yes” at the step 608 and sequentially executes processes of steps 609 and 610 described below. Then, the CPU proceeds with the process to the step 695 to terminate executing this routine once.

Step 609: The CPU sets the value of the execution flag X1 to “1”.

Step 610: The CPU executes the first and second controls. In particular, the CPU sends the buzzer control command and the displaying control command to the meter ECU 50 to cause the meter ECU 50 to execute the sound generating control and the alerting displaying control. In addition, the CPU sends the door locking control command and the lighting control command to the body ECU 40 to cause the body ECU 40 to execute the door locking control and the lighting control.

After the CPU starts to execute the first and second controls, the CPU starts the process of the routine shown in FIG. 6 from the step 600, again. When the CPU proceeds with the process to the step 602, the CPU determines “No” and proceeds with the process to a step 611. At the step 611, the CPU determines whether the predetermined terminating condition described above is satisfied. In particular, the CPU determines whether the distance Dx is equal to or longer than the second distance threshold Dth2. When the predetermined terminating condition is not satisfied, the CPU determines “No” at the step 611 and keeps executing the process of the step 610.

On the other hand, when the predetermined terminating condition is satisfied, the CPU determines “Yes” at the step 611 and sequentially executes processes of steps 612 and 613 described below. Then, the CPU proceeds with the process to the step 695 to terminate executing this routine once.

Step 612: The CPU executes a predetermined terminating process. Thereby, the CPU terminates sending the door locking control command, the lighting control command, the buzzer control command, and the displaying control command. Thereby, an execution of the first and second controls is terminated.

Step 613: The CPU sets the value of the execution flag X1 to “0”.

When the opening operation is carried out to the swing door (11a, 11b), the embodiment apparatus configured as described above sets the first distance D1 for the swing door as the first threshold distance Dth1. When the opening operation is carried out to the slide door (11c, 11d), the embodiment apparatus configured as described above sets the second distance D2 for the slide door as the first threshold distance Dth1. The second distance D2 is shorter than the first distance D1. As described above, the embodiment apparatus changes the first threshold distance Dth1 of the second condition, depending on the door to which the opening operation is carried out, i.e., depending on which of the swing door and the slide door the opening operation is carried out to when the vehicle has the doors 11 having the different maximum opening amounts. Thus, the embodiment apparatus sets the second condition in consideration of the maximum opening amount of the door to which the opening operation is carried out and executes the first and second controls in response to the second condition becoming satisfied.

For example, when (i) there is a moving object behind the vehicle VA, (ii) the moving object is likely to pass the vehicle VA, keeping away from the vehicle VA in the width direction of the vehicle VA, and (iii) the opening operation is carried out to the slide door (11c, 11d), the moving object is unlikely to come close to the slide door (11c, 11d) since the maximum opening amount of the slide door is small. When the opening operation is carried out to the slide door having the small maximum opening amount, the embodiment apparatus sets the first threshold distance Dth1 to a value (D2) smaller than a value (D1) set for the opening operation carried out to the swing door. Thus, the second condition is not satisfied in the situation described above. Thus, the embodiment apparatus does not execute the first and second controls. Thus, the occupants of the vehicle VA do not feel bothersome.

It should be noted that the invention is not limited to the aforementioned embodiments, and various modifications can be employed within the scope of the invention.

### MODIFIED EXAMPLE 1

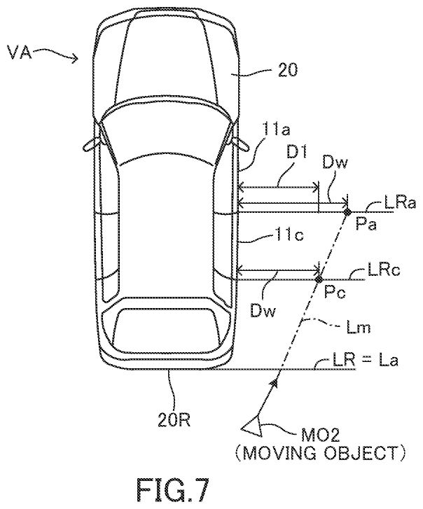

The distance Dw used in the second condition is not limited to one described above. The distance Dw may be a distance in the width direction of the vehicle VA between the position of the vehicle VA and the predicted position of the moving object coming at the side of the door DR_op. As shown in FIG. 7, when (i) there is a moving object MO2 such as a walking person behind the vehicle VA, and (ii) the opening operation is carried out to the front door 11a, the vehicle control ECU 30 may set a line LRa which extends in the width direction of the vehicle VA from the rear end portion of the door DR_op, i.e., the front door 11a. Then, the vehicle control ECU 30 may acquire, as the distance Dw, a distance in the width direction of the vehicle VA between the vehicle VA and the intersecting point Pa of the line LRa and the extension line Lm of the moving direction of the moving object MO2.

Although the moving object MO2 moves, keeping away from the vehicle VA, the distance between the vehicle VA and the moving object MO2 reaching the line La, i.e., the first line LR, is short. Thus, when the distance between the vehicle VA and the moving object MO2 reaching the line La is acquired as the distance Dw, the second condition is satisfied. However, the moving object MO2 moves, keeping away from the vehicle VA. Thus, the moving object MO2 is unlikely to come close to the front door 11a. In this situation, if the first and second controls are executed, the occupants of the vehicle VA may feel bothersome.

According to this modified example, the vehicle control ECU 30 may acquire, as the distance Dw, the distance between the vehicle VA and the predicted position Pa of the moving object MO2 coming at the side of the door DR_op. As shown in FIG. 7, the distance Dw is greater than the first threshold distance Dth1, i.e., the first distance D1. Thus, the second condition is not satisfied. As such, the vehicle control ECU 30 does not execute the first and second controls when the moving object MO2 moves, keeping away from the vehicle VA. Thus, the occupants of the vehicle VA do not feel bothersome. Thereby, the vehicle control ECU 30 executes the first and second controls under an appropriate situation that the moving object MO2 is likely to come close to the door DR_op, i.e., the front door 11a.

In another example, when (i) there is a moving object MO2 behind the vehicle VA, and (ii) the opening operation is carried out to the rear door 11c, the vehicle control ECU 30 may set a line LRc which extends in the width direction of the vehicle VA from the rear end portion of the door DR_op, i.e., the rear door 11c as shown in FIG. 7. Then, the vehicle control ECU 30 may acquire, as the distance Dw, the direction in the width direction of the vehicle VA between the vehicle VA and the intersecting point Pc of the line LRc and the extension line Lm of the moving direction of the moving object MO2. Thereby, the vehicle control ECU 30 executes the first and second controls under the appropriate situation that the moving object MO2 is likely to come close to the door DR_op, i.e., the rear door 11c.

### MODIFIED EXAMPLE 2

The condition A3 of the first condition is not limited to one described above. The condition A3 may be replaced with one or both of conditions A4 and A5 described below.

The condition A4 is a condition that the moving speed Vs of the object is greater than a second speed threshold Vth2. The second speed threshold Vth2 is greater than the first speed threshold Vth1.

The condition A5 is a condition that the distance in the longitudinal direction of the vehicle VA between the vehicle VA and the object, is shorter than a predetermined third distance threshold Dth3.

### MODIFIED EXAMPLE 3

The vehicle control ECU 30 may be configured to execute one of the first and second controls when the first and second conditions are both satisfied.

### MODIFIED EXAMPLE 4

The vehicle control ECU 30 determines whether the first and second conditions are satisfied when the occupant gets out of the vehicle VA. In this connection, the vehicle control ECU 30 may be configured to determine whether the first and second conditions are satisfied when the occupant gets in the vehicle VA. The opening operation of opening the door 11 may be an operation carried out to the outside lever 13. For example, the vehicle control ECU 30 may determine that the opening operation is carried out when at least one of the outside levers 13 is operated. Then, the vehicle control ECU 30 may determine whether the first and second conditions are satisfied. When the first and second conditions are satisfied, the vehicle control ECU 30 may execute the second control.

### MODIFIED EXAMPLE 5

The opening operation of opening the door 11 is not limited to the above-described operation carried out to the inside lever 12 or the outside lever 13. Switches for opening the doors 11 may be provided near the driver's seat or the doors 11. In this case, the opening operation may be an operation carried out to the switch. In another example, a button for opening the doors may be provided on a smart key. In this case, the opening operation may be an operation carried out to the button provided on the smart key. In further another example, a request of opening the door 11 may be sent to a communication device (not shown) of the vehicle VA from a portable device such as a smart phone. In this case, the opening operation may be an operation on the portable device for sending the request of opening the door 11 to the communication device.

In further another example, the vehicle control ECU 30 may be configured to estimate that the occupant is about to carry out the opening operation with a so-called driver monitor technique disclosed in JP 2013-152700 A. For example, the vehicle control ECU 30 may execute a driver monitor process with a camera provided in the vehicle VA. When a hand of the occupant approaches the door 11, the vehicle control ECU 30 may determine that the opening operation is about to be carried out. In this case, the vehicle control ECU 30 determines “Yes” at the step 603 of the routine shown in FIG. 6. In further another example, the vehicle control ECU 30 may be configured to estimate that the opening operation is about to be carried out with sensors provided on or near the doors 11.

### MODIFIED EXAMPLE 6

The configuration described above may be applied to other vehicles as long as the other vehicles have doors having the different maximum opening amounts. That is, the configuration described above may be applied to the vehicles having a combination of the doors other than the combination of the swing doors and the slide doors. It should be noted that the doors having types different from the types of the swing doors and the slide doors are, for example, doors which open outward and upward via hinge mechanisms (so-called butterfly doors).

### MODIFIED EXAMPLE 7

Sensors for acquiring the object information are not limited to the radar sensors 14. The vehicle may have camera sensors and/or ultrasonic wave sensors in place of or in addition to the radar sensor 14. The camera sensors and the ultrasonic wave sensors may be provided on the rear portion 20R of the vehicle body 20, facing rearwards. The ultrasonic wave sensor transmits ultrasonic waves in pulse manner to a predetermined area and receives reflected ultrasonic waves reflected on the objects. The ultrasonic wave sensor acquires reflection point distances between reflection points and the ultrasonic wave sensor, based on time taken from transmitting the ultrasonic waves to receive the reflected ultrasonic waves. The reflection points are points on the object on which the transmitted ultrasonic waves are reflected. The vehicle control ECU 30 may be configured to acquire information on the reflection point distances from the ultrasonic wave sensors and calculate the object information on the objects in a rear area behind the vehicle, based on the acquired information on the reflection point distances. The camera sensor is, for example, a digital camera which has imaging elements such as a CCD (charge coupled device) and a CIS (CMOS image sensor). The camera sensor acquires image data of a situation including the objects around the vehicle at a predetermined frame rate. The vehicle control ECU 30 may be configured to acquire the image data from the camera sensors and calculate the object information on the objects in the rear area behind the vehicle, based on the acquired image data. In one or more embodiments, the vehicle may have the radar sensors and/or ultrasonic sensors and/or the camera sensors.

What is claimed is:

1. A vehicle control apparatus, comprising:
doors provided on a vehicle, including (i) at least one first door which has a first maximum opening amount and (ii) at least one second door which has a second maximum opening amount smaller than the first maximum opening amount;
at least one sensor which acquires object information on objects in a rear area behind the vehicle; and
a control unit which is configured to execute one or both of a first control and a second control when the control unit determines that (i) an opening operation of opening the door is carried out or is about to be carried out, and (ii) a first condition and a second condition are satisfied, based on the object information,
the first control being a control of alerting occupants of the vehicle,
the second control being a control of preventing the door to which the opening operation is carried out or is about to be carried out from opening,
the first condition being a condition that a moving object approaches the vehicle from behind the vehicle,
the second condition being a condition that a moving object distance between a position of the vehicle and a predicted position of the moving object coming near the vehicle, is shorter than or equal to a distance threshold,
wherein the control unit is configured to:
set the distance threshold to a first value when the opening operation is carried out or is about to be carried out to at least one first door; and
set the distance threshold to a second value smaller than the first value when the opening operation is carried out or is about to be carried out to the at least one second door.

2. The vehicle control apparatus as set forth in claim 1, wherein the control unit is configured to calculate, as the moving object distance, a distance between a position of the vehicle and a predicted position of the moving object coming at the side of the door to which the opening operation is carried out or is about to be carried out.
